(19) United States
(12) Patent Application Publication
(10) Pub. No.: US 2026/0178040 A1
(43) Pub. Date: Jun. 25, 2026

(54) VEHICLE-GUIDING SYSTEM

(71) Applicant: Yuriy Vysochan, Huntingdon Valley, PA (US)

(72) Inventor: Yuriy Vysochan, Huntingdon Valley, PA (US)

(21) Appl. No.: 19/001,475

(22) Filed: Dec. 25, 2024

(51) Int. Cl. G05D 1/60; G05D 107/13; G05D 109/10; G05D 111/10; G06K 7/14

(52) U.S. Cl. CPC G05D 1/60; G06K 7/1417; G05D 2107/13; G05D 2109/10; G05D 2111/10

(57) ABSTRACT

In some embodiments, a motorized, terrestrial vehicle has wheels and steering arms on the vehicle's left side, wheels and steering arms on the vehicle's right side, and a control system that selectively configures each steering arm to be in either a raised, disengaged configuration or a lowered, engaged configuration to guide the vehicle through a fork in a vehicle path. An outer curb roller of an engaged steering arm engages with a corresponding curb of the vehicle path to guide the vehicle in that direction, while an outer curb roller of a disengaged steering arm does not engage with a corresponding curb of the vehicle path, thereby allowing the vehicle to be guided in the other direction. The control system may guide the vehicle based on symbols (e.g., barcodes) read by the vehicle's symbol reader(s). The vehicle may be an electric vehicle that receives electrical power from the vehicle path.

### BACKGROUND

### Field Of The Disclosure

The present disclosure relates to techniques for steering motorized, terrestrial vehicles, such as, without limitation, trains, cars, trucks, and buses, along corresponding vehicle paths.

### Description of the Related Art

This section introduces aspects that may help facilitate a better understanding of the disclosure. Accordingly, the statements of this section are to be read in this light and are not to be understood as admissions about what is prior art or what is not prior art.

Most conventional motorized, terrestrial vehicles, such as cars, trucks, and buses, are steered along roads by controlling the angle of the front wheels relative to the rest of the vehicle. When such a vehicle approaches a typical fork in the road, the angle of the front wheels is (i) turned to the left to cause the vehicle to travel to the left at the fork and (ii) turned to the right to cause the vehicle to travel to the right at the fork.

When a conventional train (another type of motorized, terrestrial vehicle) approaches a fork in a railroad track, the railroad track itself has movable rails that pivot either left or right to guide the train to either the left or the right at the fork.

### SUMMARY

The present disclosure is directed to a new technique for guiding motorized, terrestrial vehicles, such as (without limitation) trains, cars, trucks, and buses, at a fork in a corresponding vehicle path.

In at least one embodiment of the present disclosure, a vehicle comprises at least one left wheel on a left side of the vehicle; at least one right wheel on a right side of the vehicle; at least one left steering arm on the left side of the vehicle and having a left outer curb roller; at least one right steering arm on the right side of the vehicle and having a right outer curb roller; and a control system adapted to selectively configure each of the left and right steering arms to be in either a raised, disengaged configuration or a lowered, engaged configuration to guide the vehicle through a fork in a vehicle path. The outer curb roller of an engaged steering arm is configured to engage with a corresponding curb of the vehicle path, and the outer curb roller of a disengaged steering arm is not configured to engage with a corresponding curb of the vehicle path.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a perspective view of an example scenario of the present disclosure involving a motorized vehicle approaching a fork in a vehicle path;

FIG. 2 is a perspective view of the vehicle path of FIG. 1 without the vehicle;

FIG. 3A is a plan view of the vehicle of FIG. 1, while FIG. 3B is an end view of the vehicle of FIG. 1;

FIG. 3C is a perspective view of one pair of wheels, their corresponding axle, and other structural components of the vehicle of FIG. 1; and

FIG. 3D is a schematic diagram of the control system for controlling the operations of the vehicle of FIG. 1.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

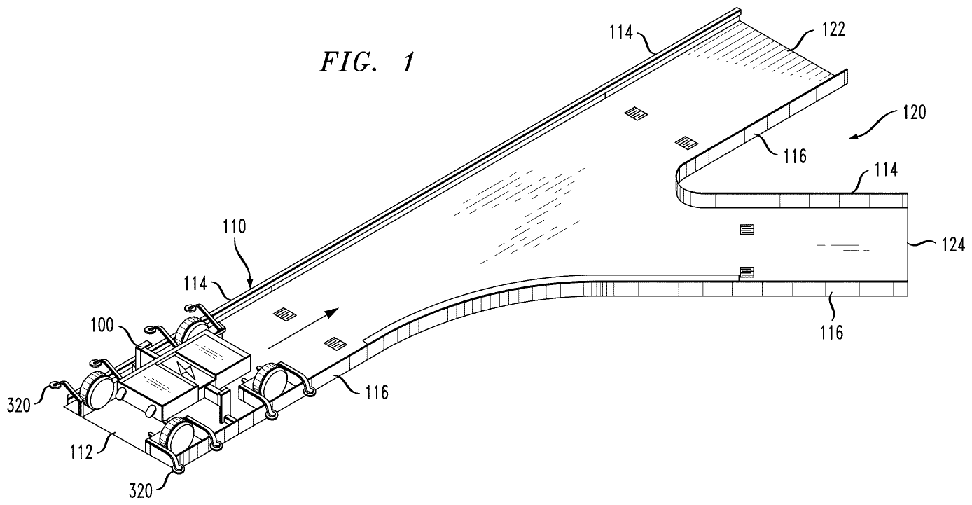

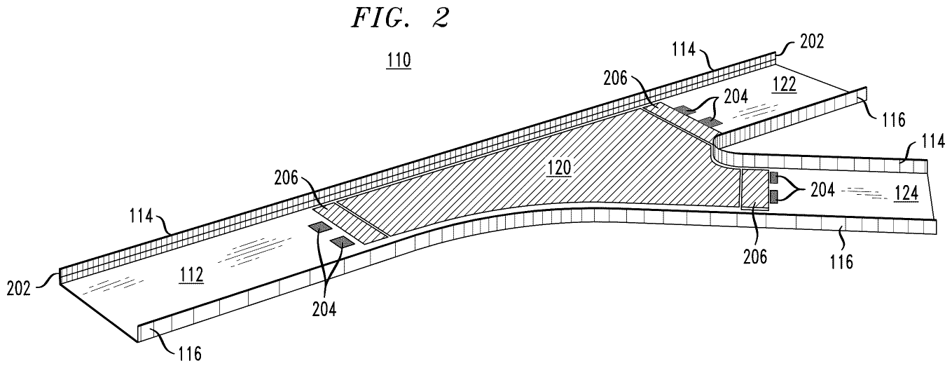

FIG. 1 is a perspective view of an example scenario of the present disclosure involving a motorized vehicle 100 approaching a fork 120 in a vehicle path 110. As used herein, the term “fork” refers to any suitable three-way intersection in a vehicle path. In the case of FIG. 1, the vehicle 100 is traveling along a “trunk” 112 of the vehicle path 110 towards the fork 120, which has a “left branch” 122 and a “right branch” 124. Depending on the situation, the vehicle 100 is controlled to guide the vehicle 100 along either the left branch 122 or the right branch 124 at the fork 120. As explained further below, in the particular example scenario shown in FIG. 1, the vehicle 100 is controlled to guide the vehicle 100 along the right branch 124 at the fork 120.

Those skilled in the art will understand that FIG. 1 (and other related figures) depict only the chassis of the vehicle 100, which will also typically have a vehicle body that is not shown in the figures.

FIG. 2 is a perspective view of the vehicle path 110 of FIG. 1 without the vehicle 100. As shown in FIG. 2, each of the trunk 112 and the left and right branches 122 and 124 has a left curb 114 and a right curb 116, where (i) the left curb 114 of the trunk 112 is contiguous with the left curb 114 of the left branch 122 and (ii) the right curb 116 of the trunk 112 is contiguous with the right curb 116 of the left branch 122. In this particular example, the right curb 116 of the left branch 122 is contiguous with the left curb 114 of the right branch 124, but that contiguity is not required for all embodiments.

As shown in the embodiment of FIG. 2, the inner sides of the left curbs 114 of the trunk 112 and the left branch 122 include an electricity supply line 202 for embodiments in which the vehicle 100 of FIG. 1 is an electric vehicle that receives electric power from the electricity supply line 202. In addition, although not visible in the view of FIG. 2, the inner sides of the right curbs 116 of the trunk 112 and the right branch 124 also include an analogous electricity supply line for embodiments involving such electric vehicles. For embodiments involving only non-electric (e.g., fuel-powered) vehicles and/or electric vehicles that do not require electric power to be provided from the curbs, the electricity supply lines of FIG. 2 may be omitted.

As shown in FIG. 2, at the transition between the trunk 112 and the fork 120, the surface of the vehicle path 110 has two barcodes 204 (or other suitable one-or two-dimensional symbols, such as QR codes) that identify information about the fork 120, such as the geographical location of the fork 120 and/or the geographical destinations associated with the left and right branches 122 and 124. Immediately following the two barcodes 204 is a determination zone 206, which is described further below.

Those skilled in the art will understand that, in scenarios different from the scenario of FIG. 1, a vehicle, like vehicle 100, may approach the fork 120 from along the left branch 122. In that case, for that scenario, the left branch 122 will be the “trunk”, the trunk 112 will be the “right branch”, and the right branch 124 will be the “left branch”. Similarly, if a vehicle, like vehicle 100, approaches the fork 120 from along the right branch 124, the right branch 124 will be the “trunk”, the trunk 112 will be the “left branch”, and the left branch 122 will be the “right branch”. As shown in FIG. 2, each branch 122/124 also has two corresponding barcodes 204 and a corresponding determination zone 206 corresponding to those alternative scenarios.

In some implementations, within each pair of barcodes 204, one barcode is to be read by vehicles traveling in one direction and the other barcode is to be read by vehicles traveling in the other direction. In other implementations, each pair of barcodes is replaced by a single barcode, for example, at the center of the vehicle path 110, that is read by vehicles traveling in either direction. In either implementation, the first barcode read by a vehicle indicates the beginning of a fork, while the second barcode indicates the end of the fork.

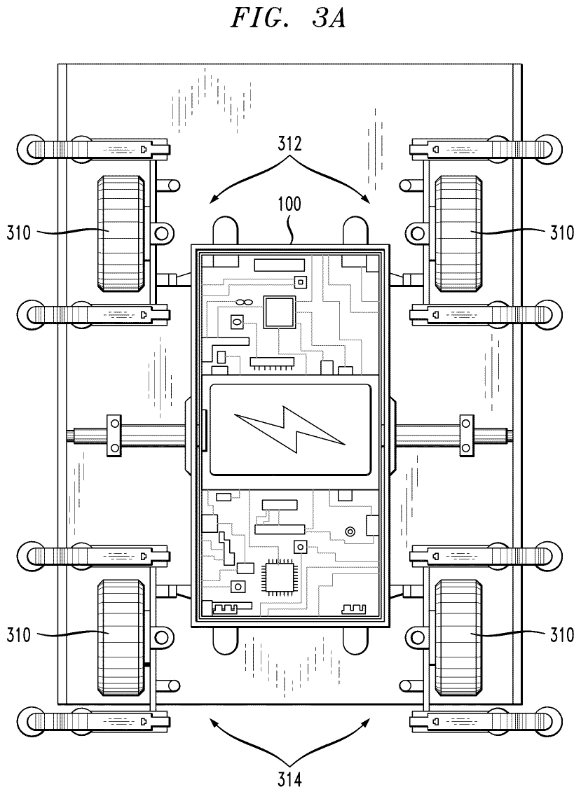

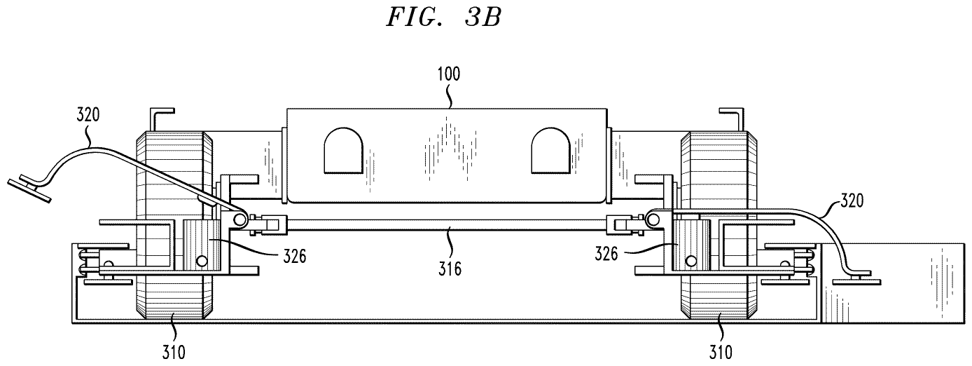

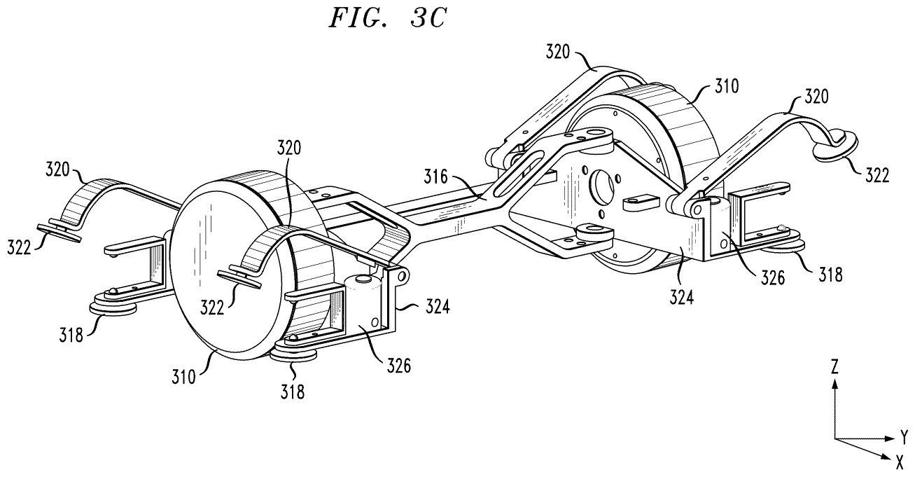

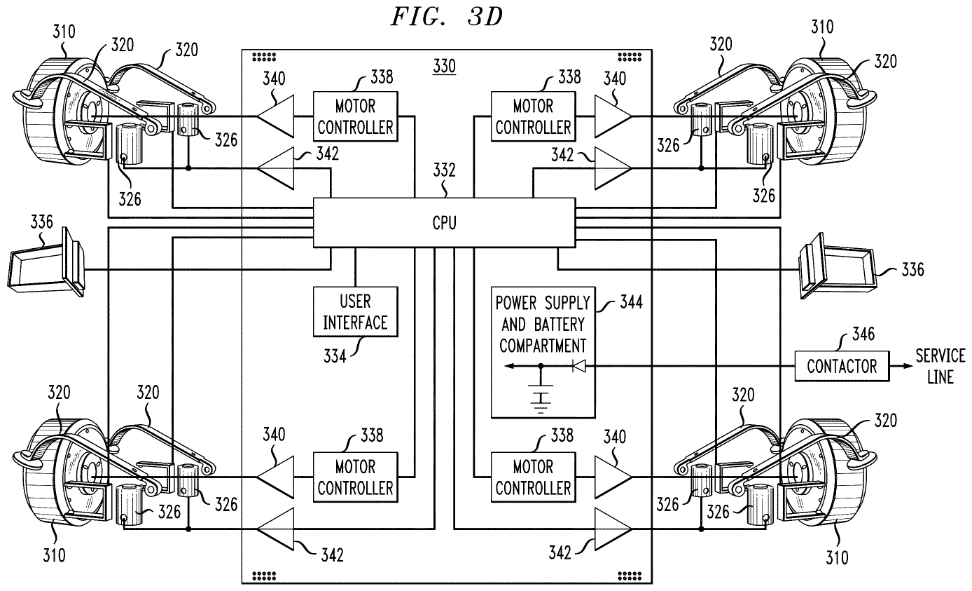

FIG. 3A is a plan view of the vehicle 100 of FIG. 1, while FIG. 3B is an end view of the vehicle 100 of FIG. 1 from the direction in which the vehicle 100 has traveled (that is, looking towards the fork 120 from behind the vehicle 100). As shown in FIG. 3A, the vehicle 100 has a front pair 312 of motor-driven wheels 310 and a rear pair 314 of motor-driven wheels 310, where the wheels 310 of each pair 312/314 are interconnected by an axle 316 (FIG. 3B). Those skilled in the art will understand that alternative vehicles may have three or more pairs of wheels.

FIG. 3C is a perspective view of one pair 312/314 of wheels 310, their corresponding axle 316, and other structural components including four inner curb rollers 318 (three of which are visible in the view of FIG. 3C) and four spring-loaded steering arms 320, each of which has an outer curb roller 322. Each wheel 310, corresponding pair of steering arms 320, and corresponding pair of inner curb rollers 318 are all rotatably coupled to a bracket 324 that is itself rotatably coupled to the axle 316, such that the wheel 310 is able to rotate about its Y-direction axis relative to the bracket 324, each steering arm 320 is able to pivot about its X-direction axis relative to the bracket 324, each inner curb roller 318 is able to rotate about its Z-direction axis relative to the bracket 324, and the bracket 324 itself is able to pivot about its Z-direction axis relative to the axle 316. In addition, each outer curb roller 322 is able to rotate relative to the end of its steering arm 320 about its Z-direction axis. Depending on the particular implementation, each inner/outer curb rollers 318/322 may independently be (i) a passive roller that is free to rotate based on its physical contact with a curb 114/116 or (ii) an active roller that is driven by a roller motor (not shown) to rotate in a desired direction to assist in propagating the vehicle 100 along the vehicle path 110.

Each spring-loaded steering arm 320 is associated with a corresponding solenoid magnet 326 (two of which are visible in the views of FIGS. 3B and 3C). When a solenoid magnet 326 is not energized, the corresponding steering arm's spring loading keeps the steering arm 320 in its “disengaged” configuration (as shown in FIG. 3C for all four steering arms 320 and in FIG. 3B for the left steering arm 320). When a solenoid magnet 326 is energized, the magnetic attraction between the magnet 326 and the corresponding steering arm 320 overcomes the steering arm's spring loading and pulls the steering arm 320 down to its “engaged” configuration (as shown in FIG. 3B for the right steering arm 320).

The distance between the left and right curbs 114 and 116 within the trunk 112 and each branch 122/124 of the vehicle path 110 is selected to be slightly larger than the distance between the outer edge of the inner curb roller 318 on the left side of the vehicle 100 and the outer edge of the corresponding inner curb roller 318 on the right side of the vehicle 100, such that, with all eight of the vehicle's steering arms 320 in their disengaged configuration, the vehicle 100 fits between the left and right curbs 114 and 116 as the vehicle 100 moves along those portions of the vehicle path 110.

The vehicle 100 is designed such that the outer curb roller 322 is located just outside the corresponding curb 114/116 when the corresponding steering arm 320 is in its engaged configuration, such as shown in FIG. 1 for the four engaged steering arms 320 on the right side of the vehicle 100 and the right curb 116 of the trunk 112. On the other hand, the vehicle 100 is designed such that the outer curb roller 322 is located above the corresponding curb 114/116 when the corresponding steering arm 320 is in its disengaged configuration, such as shown in FIG. 1 for the four disengaged steering arms 320 on the left side of the vehicle 100 and the left curb 114 of the trunk 112.

In that configuration, in the scenario of FIG. 1, as the vehicle 100 proceeds towards and then through the fork 120, the four engaged steering arms 320 on the right side of the vehicle 100 will guide the vehicle to the right towards the right branch 124 due to the engagement (i.e., physical contact) between (i) the outer curb rollers 322 on the ends of those four engaged steering arms 320 and (ii) the outer surface of the right curb 116, with the four outer curb rollers 322 of the disengaged steering arms 320 on the left side of the vehicle 100 hovering above and passing over the left curb 114.

After passing through the fork 120 and onto the right branch 124, (i) the four engaged steering arms 320 on the right side of the vehicle 100 may remain engaged or be disengaged and/or (ii) the four disengaged steering arms 320 on the left side of the vehicle 100 may remain disengaged or be engaged as the vehicle 100 travels along the right branch 124 possibly towards another fork in the vehicle path 110. Note that, if the right branch 124 has curves in it, then it might be better to engage both the left and right steering arms 320 to help guide the vehicle 100 through those curves, although the operations of the left and right inner curb rollers 318 may be sufficient to achieve that guiding.

Those skilled in the art will understand that, in order to make the vehicle 100 travel through the fork 120 towards the left branch 122, one or more (and preferably all) of the steering arms 320 on the vehicle's left side are controlled to be in their engaged configuration, while all four of the steering arms 320 on the vehicle's right side are controlled to be in their disengaged configuration.

FIG. 3D is a schematic diagram of the control system 330 for controlling the operations of the vehicle 100 of FIG. 1. At the heart of the control system 330 is a central processing unit (CPU) 332 that controls the operations of the control system 330 based on (i) programming input via user interface 334 and (ii) signals received from barcode readers 336 configured to read barcodes 204 as the vehicle 100 passes over those barcodes 204 on the vehicle path 110. In particular, the CPU 332 controls the operations of four motor controllers 338, one for each of the four motorized wheels 310, where each motor controller 338 controls the speed of rotation of its corresponding wheel 310 via a corresponding motor driver 340. The CPU 332 also controls the selective energizing and de-energizing of the four solenoid magnets 326 via corresponding solenoid drivers 342. In some implementations, each motorized wheel 310 has an internal, brushless motor (not shown) that drives the motorize wheel.

As shown in FIG. 3D, the control system 330 has a power-supply-and-battery subsystem 344 that receives electrical energy from at least one suitable contactor 346 that makes contact with the electricity supply line 202 of either the left curb 114 or the right curb 116, depending on the implementation. That electrical energy is used to power the electric vehicle 100 and to charge the vehicle's battery(ies).

In operation, the CPU 332 may be pre-programmed to follow a particular route through the fork 120 of FIGS. 1 and 2. When the vehicle 100 reaches the barcodes 204 at the transition between the trunk 112 and the fork 120 and as the vehicle 100 continues to travel through the corresponding determination zone 206, the vehicle's barcode readers 336 will read those barcodes 204 and transmit corresponding barcode signals to the CPU 332, which will determine, based on those barcode signals and its programming, whether the vehicle 100 is to travel through the fork 120 towards the left branch 122 or the right branch 124. The CPU 332 will then control one or more of the vehicle's solenoid magnets 326 to engage and/or disengage the vehicle's steering arms 320 as needed to guide the vehicle 100 along the desired direction through the fork 120.

In addition to or instead of barcodes 204 and barcode readers 336, there may be index plates (not shown) having perforations or other indices on the sides of the vehicle path 110 and optical sensors (not shown) on the vehicle 100 to read those index plates to identify the fork 120 in the vehicle path 110.

Those skilled in the art will understand that the vehicle path 110 of FIGS. 1 and 2 may have series of one or more or many additional forks analogous to the fork 120 of FIGS. 1 and 2 connected to the trunk 112 and/or each of the branches 122 and 124 with branches from different forks possibly meeting one another at other forks to form a mesh topology that enables vehicles like the vehicle 100 of FIG. 1 to travel from one location within the mesh to any of two or more and possibly all other locations within the mesh by navigating through an appropriate sequence of the mesh's forks.

Note that, in preferred embodiments, the control system 330 may be programmed to drive the vehicle 100 either forward or backward.

Although embodiments have been described in which the steering arms 320 are engaged and disengaged using solenoid magnets 326, those skilled in the art will understand that there are other types of actuators that can be used to engage and disengage the steering arms 320, such as (without limitation) stepper or servo motors.

Although embodiments have been described as having two or more wheels on each side of the vehicle, the disclosure includes other embodiments, such as three-wheel vehicles having a single left wheel, a single right wheel, and a third wheel at a mid-line of the vehicle.

Although embodiments have been described as having two steering arms for each wheel, in general, vehicles of the disclosure may have one or more steering arms on the vehicle's left side and one or more steering arms on the vehicle's right side.

Although embodiments have been described as having symbol (e.g., barcode) readers that read symbols printed on the vehicle path, in other embodiments, other techniques are used to identify the current location of the vehicles, such as wireless communications or GPS geolocation technology.

Although embodiments have been described in the context of “outside” vehicles, such as trains, cars, trucks, and buses, the technology can also be implemented in the context of “inside” vehicles, such as those used to move items within a factory, warehouse, or distribution center.

In certain embodiments, the present disclosure is a vehicle comprising (i) at least one left wheel on a left side of the vehicle; (ii) at least one right wheel on a right side of the vehicle; (iii) at least one left steering arm on the left side of the vehicle and having a left outer curb roller; (iv) at least one right steering arm on the right side of the vehicle and having a right outer curb roller; and (v) a control system adapted to selectively configure each of the left and right steering arms to be in either a raised, disengaged configuration or a lowered, engaged configuration to guide the vehicle through a fork in a vehicle path. The outer curb roller of an engaged steering arm is configured to engage with a corresponding curb of the vehicle path, and the outer curb roller of a disengaged steering arm is not configured to engage with a corresponding curb of the vehicle path.

In at least some of the above embodiments, the vehicle has at least two left wheels on the vehicle's left side and at least two right wheels on the vehicle's right side.

In at least some of the above embodiments, the vehicle has two steering arms for each wheel.

In at least some of the above embodiments, each steering arm has an outer curb roller configured (i) to engage with the corresponding curb of the vehicle path when the steering arm is in its engaged configuration and (ii) to not engage with the corresponding curb of the vehicle path when the steering arm is in its disengaged configuration.

In at least some of the above embodiments, the vehicle further comprises at least one symbol reader adapted to read a symbol associated with the vehicle path, wherein the control system is adapted to control the left and right steering arms to guide the vehicle through the fork based on signals from the at least one symbol reader.

In at least some of the above embodiments, the symbol is a barcode.

In at least some of the above embodiments, the symbol is on an index plate and the at least one symbol reader is an optical sensor configured to read the symbol on the index plate.

In at least some of the above embodiments, the vehicle further comprises a solenoid magnet for each steering arm, wherein each steering arm is spring loaded and pivotally connected to other structure of the vehicle, and the control system is adapted to (i) energize the solenoid magnet to overcome the spring loading to engage the corresponding steering arm and (ii) de-energize the solenoid magnet to allow the spring loading to disengage the corresponding steering arm.

In at least some of the above embodiments, the vehicle is an electric vehicle having motorized wheels.

In at least some of the above embodiments, the vehicle further comprises at least one contactor adapted to receive electrical energy from an electricity supply line of the vehicle path.

In at least some of the above embodiments, the vehicle further comprises at least one inner curb roller on each side of the vehicle.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure. For example, a relatively thin layer of adhesive or other suitable binder can be used to implement such “direct attachment” of the two corresponding components in such physical structure.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A vehicle comprising:
at least one left wheel on a left side of the vehicle;
at least one right wheel on a right side of the vehicle;
at least one left steering arm on the left side of the vehicle and having a left outer curb roller;
at least one right steering arm on the right side of the vehicle and having a right outer curb roller; and
a control system adapted to selectively configure each of the left and right steering arms to be in either a raised, disengaged configuration or a lowered, engaged configuration to guide the vehicle through a fork in a vehicle path, wherein:
the outer curb roller of an engaged steering arm is configured to engage with a corresponding curb of the vehicle path; and
the outer curb roller of a disengaged steering arm is not configured to engage with a corresponding curb of the vehicle path.

2. The vehicle of claim 1, wherein the vehicle has at least two left wheels on the vehicle's left side and at least two right wheels on the vehicle's right side.

3. The vehicle of claim 2, wherein the vehicle has two steering arms for each wheel.

4. The vehicle of claim 1, wherein each steering arm has an outer curb roller configured (i) to engage with the corresponding curb of the vehicle path when the steering arm is in its engaged configuration and (ii) to not engage with the corresponding curb of the vehicle path when the steering arm is in its disengaged configuration.

5. The vehicle of claim 1, further comprising at least one symbol reader adapted to read a symbol associated with the vehicle path, wherein the control system is adapted to control the left and right steering arms to guide the vehicle through the fork based on signals from the at least one symbol reader.

6. The vehicle of claim 5, wherein the symbol is a barcode.

7. The vehicle of claim 5, wherein the symbol is on an index plate and the at least one symbol reader is an optical sensor configured to read the symbol on the index plate.

8. The vehicle of claim 1, further comprising a solenoid magnet for each steering arm, wherein:
each steering arm is spring loaded and pivotally connected to other structure of the vehicle; and
the control system is adapted to (i) energize the solenoid magnet to overcome the spring loading to engage the corresponding steering arm and (ii) de-energize the solenoid magnet to allow the spring loading to disengage the corresponding steering arm.

9. The vehicle of claim 1, wherein the vehicle is an electric vehicle having motorized wheels.

10. The vehicle of claim 9, further comprising at least one contactor adapted to receive electrical energy from an electricity supply line of the vehicle path.

11. The vehicle of claim 1, further comprising at least one inner curb roller on each side of the vehicle.

12. The vehicle of claim 1, wherein the vehicle is an electric vehicle further comprising:
at least one contactor adapted to receive electrical energy from an electricity supply line of the vehicle path;
two left wheels on the left side of the vehicle, wherein the wheels are motorized;
two right wheels on the right side of the vehicle, wherein the wheels are motorized;
two steering arms for each wheel, each steering arm having an outer curb roller;
two inner curb rollers for each wheel; and
at least one symbol reader adapted to read a symbol associated with the vehicle path, wherein:
each steering arm has an outer curb roller configured (i) to engage with the corresponding curb of the vehicle path when the steering arm is in its engaged configuration and (ii) to not engage with the corresponding curb of the vehicle path when the steering arm is in its disengaged configuration; and
the control system is adapted to control the left and right steering arms to guide the vehicle through the fork based on signals from the at least one symbol reader.

13. The vehicle of claim 12, wherein the symbol is a barcode.

14. The vehicle of claim 12, wherein the symbol is on an index plate and the at least one symbol reader is an optical sensor configured to read the symbol on the index plate.

15. The vehicle of claim 12, further comprising a solenoid magnet for each steering arm, wherein:
each steering arm is spring loaded and pivotally connected to other structure of the vehicle; and
the control system is adapted to (i) energize the solenoid magnet to overcome the spring loading to engage the corresponding steering arm and (ii) de-energize the solenoid magnet to allow the spring loading to disengage the corresponding steering arm.
